(19) United States
(12) Patent Application Publication
(10) Pub. No.: US 2015/0007330 A1
(43) Pub. Date: Jan. 1, 2015

(54) SCORING SECURITY RISKS OF WEB BROWSER EXTENSIONS

(71) Applicant: Laurent Gomez, Le Cannet (FR)

(72) Inventor: Laurent Gomez, Le Cannet (FR)

(73) Assignee: SAP AG, Walldorf (DE)

(21) Appl. No.: 13/927,946

(22) Filed: Jun. 26, 2013

(51) Int. Cl. G06F 21/57

(52) U.S. Cl. CPC G06F 21/577
USPC 726/25

(57) ABSTRACT

A computer-implemented method involves obtaining a web browser extension to a web browser, extracting the web browser extension's imported library dependencies, and evaluating security risks associated with the web browser extension and the imported library dependencies.

### BACKGROUND

A web browser (commonly referred to as a browser) is a software application for retrieving, presenting and traversing information resources on the World Wide Web. An information resource is identified by a Uniform Resource Identifier (URI) and may be a web page, image, video or other piece of content. Hyperlinks present in resources enable users easily to navigate their browsers to related resources. A web browser can also be defined as an application software or program designed to enable users to access, retrieve and view documents and other resources on the Internet. A web browser can also be used to access information provided by web servers in private networks or files in file systems.

A browser extension, plug-in or add-on (collectively “extension”) is a computer program that extends the functionality of a web browser in some way. In order to extend the standard functionalities of their web browsers, software vendors (e.g. Microsoft, Mozilla, Google, Apple) configure their web browsers to allow installation of extensions by users. The extensions enhance the web browser with additional functionalities (e.g., for web browser debugging, playing or downloading video, gaming, etc.). Any third party developer can develop and distribute a new extension for a web browser based on the development framework of the web browser, which is provided by the web browser software vendor.

However, the very ease of development, distribution and installation of such third-party developed extensions in the web browser presents a major source of security flaws in IT systems. Indeed, extensions are meant to run, within the web browser, with the same security privileges in the IT systems as the web browser.

Further, a web browser extension may include or use libraries, which are software modules designed to perform commonly required functions. Libraries imported by an extension into a web browser are also susceptible to unintentional security flaws and intentional malicious code.

Any security flaw, intentional or not, can be exploited by an intruder in order to gain full privileges on an IT system. An intruder may exploit the security flaw to steal, modify or delete information (e.g. personal information, credit card numbers, passwords, etc.) or to install malicious software (e.g. Trojans, bots, etc.) in the IT system.

Consideration is now being given to ways of enabling users to gain knowledge of the security risks associated with particular web browser extensions that they may choose to download or install in a web browser.

### SUMMARY

In a general aspect, a computer-based system for security evaluations of a web browser extension is implemented by instructions recorded on a non-transitory computer readable storage medium and executable by at least one processor. The computer-based system includes a security evaluation tool configured to evaluate security risks associated with a web browser extension added to a web browser. The security evaluation tool is configured to extract dependencies of one or more imported libraries associated with the web browser extension.

In an aspect, the security evaluation tool includes a web browser extension security validator and a library security validator. The web browser extension security validator is configured to evaluate security risks associated with the web browser extension, and the library security validator is configured to evaluate security risks associated with the one or more imported libraries.

In a further aspect, the web browser extension security validator and the library security validator include at least one static source code scanning tool. The static source code scanning tool may be used to examine the source code of the web browser extension and or the libraries' source codes for patterns of identified vulnerabilities.

In yet another aspect, the web browser extension security validator and the library security validator are configured to evaluate security risks associated with the web browser extension for one or more key performance indicators (KPIs) and assign a security score for each of the one or more KPIs. The one or more KPIs include at least one of: origin of the extension, popularity of the extension, known vulnerabilities in the extension, and nature of the extension. The web browser extension security validator is configured to assign a quantitative security score to the web browser extension for each of the one or more KPIs evaluated. The library security validator is configured to assign a quantitative security score to each library for each of the one or more KPIs evaluated.

In another aspect, the security evaluation tool is configured to compute an aggregate security score for the web browser extension from the security scores assigned to the web browser extension for each of the one or more KPIs evaluated and the security scores assigned to each library for each of the one or more KPIs evaluated.

In yet another aspect, the security evaluation tool is configured to determine whether the aggregate security score is above or below a pre-determined threshold value indicating that there may be an unacceptable level of security risks associated with the web browser extension.

In a general aspect, a computer-implemented method for security evaluations of a web browser extension is carried out by causing at least one processor to execute instructions recorded on a computer-readable storage medium. The computer-implemented method includes obtaining a web browser extension to a web browser, extracting the web browser extension's imported library dependencies, and evaluating security risks associated with the web browser extension and the imported library dependencies.

In a general aspect, a computer program product is embodied in non-transitory computer-readable media carrying executable code, which code when executed obtains a web browser extension to a web browser, extracts the web browser extension's imported library dependencies, and evaluates security risks associated with the web browser extension and the imported library dependencies.

The details of one or more implementations are set forth in the accompanying drawings and the description below. Other features will be apparent from the description and the drawings, and from the claims.

### BRIEF DESCRIPTION OF THE DRAWINGS

FIG. 1 is a block diagram illustration of an example computer-based system for providing security evaluations of a web browser extension to a user, in accordance with principles of the disclosure herein.

FIG. 2 is a flow diagram illustration of an example computer-implemented method for providing security risk evaluations of a web browser extension, in accordance with principles of the disclosure herein.

FIG. 3 is a flowchart illustrating the logic of an example method that is implemented to continuously or regularly monitor updates to a web browser extension to a web browser installed on a computer system, in accordance with the principles of the disclosure herein.

### DETAILED DESCRIPTION

Web browser extensions, which may be developed by third party developers, are widely available and downloaded by users to enhance or add functionalities to their standard web browsers (e.g., Mozilla Firefox, Internet Explorer, Chrome, etc.). The web browser extensions may, for example, include extensions for development utilities, security, gaming, video, etc.

A process for providing security risk evaluations of a web browser extension involves assessing and quantitatively scoring security risks associated with the web browser extension, in accordance with the principles of the disclosure herein.

Installation of the web browser extension may involve importing associated libraries. Assessing and quantitatively scoring security risks associated with the web browser extension may include assessing and scoring security risks associated with the imported libraries that the web browser extension may use or depend on.

Assessing and quantitatively scoring security risks associated with the web browser extension may be conducted when the web browser extension is first installed, at run time and/or when the web browser extension updated. The assessing and scoring of security risks associated with the web browser extension may also be conducted even when a new library associated with the web browser extension is installed or updated.

The process for providing security risk evaluations of a web browser extension, which may be of any type, may be based on evaluation of source code scans and/or evaluation of other empirical criteria, for example, the origin, source, and public popularity of the web browser extension. The process may generate a quantitative metric or score (e.g., a numeric score or letter grade) for the security risks associated with the downloading, installation, running or updating of the web browser extension by a user. The quantitative metric or score for the security risks may be an aggregate of individual scores for various security criteria (e.g., source code scans, origin, source, and public popularity) considered in the security evalauation process.

As noted above, the process for providing security risk evaluations of a web browser extension may involve source code scans. The source code scans may be conducted using static source code scanning tools that are publicly available as either open, quasi open or proprietary tools. An example proprietary source code scanning tool may be “Fortify Source Code Analysis” tool, which is described at website fortify.com. An example open source code scanning tool may be the “FlawFinder” tool, which is described at website dwheeler.com\flaw finder. These tools (or like tools) may be configured to examine source code for patterns of identified vulnerabilities. The output of these tools may be used for security auditing of the source code against a list of identified vulnerabilities in the source code.

The process for providing security risk evaluations of a web browser extension as described herein goes beyond mere source code scans or finding of malicious software in that it further explores the dependencies of web browser extension with other libraries or frameworks. The process further involves evaluating the security risks associated with the extension and the imported library dependencies, computing a security score for the extension, and computing security scores for the imported library dependencies. Computing security scores may be performed for a set of key performance indicators (KPIs) for both the web browser extension and the associated libraries. An example set of KPIs may include KPIs such as known source code vulnerabilities, popularity (i.e. number of users), and origin of the web browser extension or library, download site of web browser extension (e.g., official or unofficial web site) and a number of any other known security vulnerabilities.

For each KPI, a specific scoring algorithm may be applied to compute a security score (e.g., a numeric value or letter grade). For example, for the source code vulnerabilities KPI, a source code scanning tool may be used to determine the number of identified flaws in a specific piece of software. Reputation of the origin or the developer, and/or popularity of the extension may be taken into account into the computation of the security score. After individual KPIs are scored, the process may involve generating an aggregate security score as a weighted sum of the individual KPI scores.

Analysis of the results of the security risk evaluations may involve a determination of whether the aggregated security score value is beyond a pre-determined threshold value indicating that there may be an unacceptable level of security risks associated with the web browser extension. In such case, depending on the score, different actions may be undertaken automatically, for example, a simple notification to the user, un-installation of the extension, alert email sent to the administrator, etc.

The process for providing security risk evaluations of a web browser extension may further involve retrieving detailed information from external information sources (e.g., common weakness enumeration available at web site cwe.miter.org) regarding the security risks. The retrieved detailed information may be provided to the user and/or system administrator for further action.

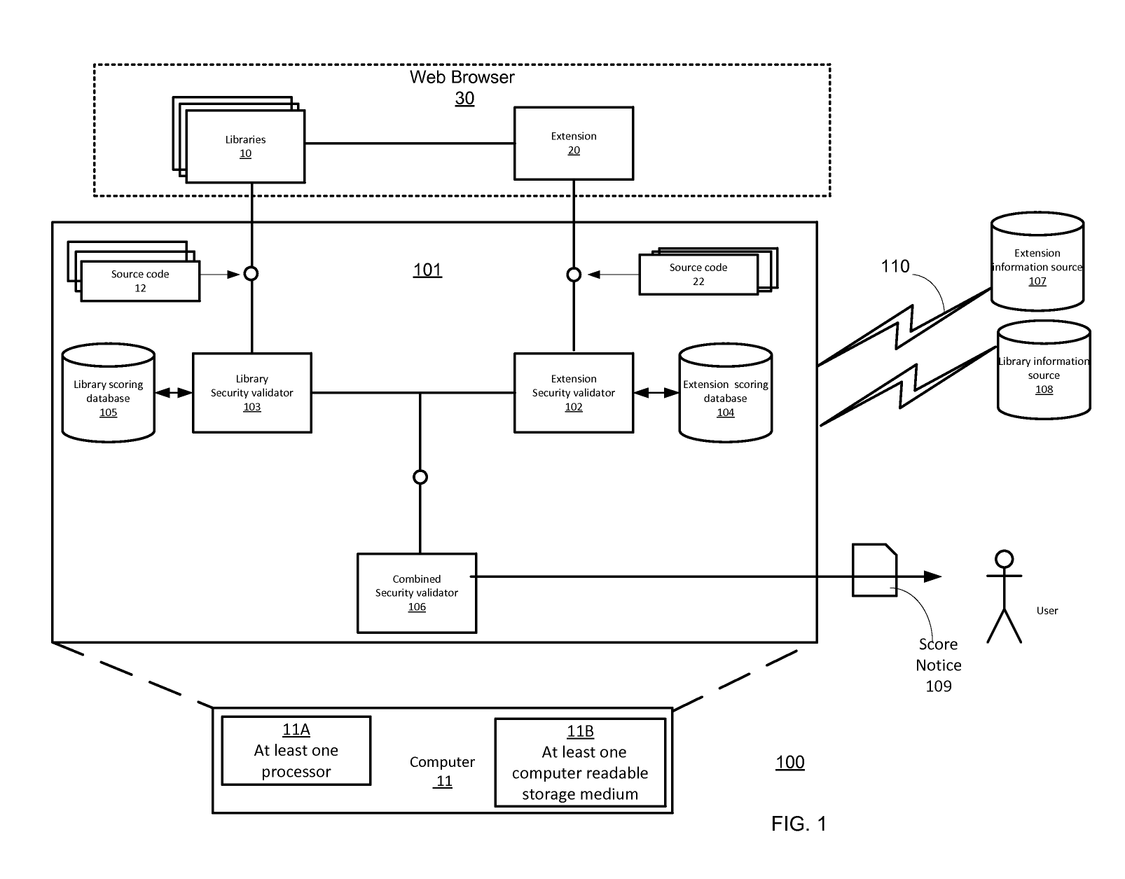

FIG. 1 shows an example computer-based system 100 for security risk evaluations of a web browser extension 20 for a web browser 30 on a user's computer, in accordance with principles of the disclosure herein. System 100 may be deployed to provide a user (e.g., an administrator) an assessment of security risks that may arise from installation and use of web browser extension 20. System 100 may also provide the user with an assessment of security risks that may arise from installation and use of libraries 10 associated with web browser extension 20. The security risk evaluations may be conducted at initial installation of web browser extension or associated libraries, at any time there are updates to the web browser extension or associated libraries, and/or at runtime.

System 100, like web browser 30 itself, may be deployed on one or more physical or virtual hosts in a computer network. In the example configuration shown in FIG. 1, system 100 includes security evaluation tool 101, which may be linked by a communication link 110 or network (e.g., the Internet or a private network) to information sources (e.g., extension information source 107 and library information source 108), which contain information (e.g., source code, statistics of use, etc.) on the web browser extension and associated libraries. An example information source 107/108 may be the web site “Build With Technology Usage Statistics” trends.builtwith.com.

Security evaluation tool 101 may include an extension security validator 102, a library security validator 103, and a combined security validator 106. Security evaluation tool 101 may include or be linked to one or more databases (e.g., an extension scoring database 104 and a library scoring database 105).

As noted previously, security evaluation tool 101, like web browser 30 itself, may be deployed on one or more physical or virtual hosts in a computer network. In the example of FIG. 1, security evaluation tool 101 along with web browser 30 is illustrated as executing in the context of at least one computer 11. As shown, and as would be appreciated, computer 11 may include or utilize at least one processor 11A, as well as at least one computer readable storage medium 11B. Of course, the at least one processor 11A and the computer readable storage medium 11B may be understood to represent or include any known or future examples of corresponding components that may be utilized in the context of computer 11. Further, it may be appreciated that any additional, or otherwise conventional, components may be utilized in the context of computer 11, including, for example, components related to power, communications, input/output functions, network connections and other conventional features and functions that would be understood by one of skill in the art to be potentially implemented in the context of computer 11.

Moreover, although computer 11 is illustrated in the example of FIG. 1 as a single computer, it may be understood that computer 11 may represent two or more computers in communication with one another. Therefore, it will also be appreciated that any two or more components of system 100 may similarly be executed using some or all of the two or more computing devices in communication with one another. Conversely, it also may be appreciated that various components illustrated as being external to computer 11 may actually be implemented therewith.

In operation, users may download or otherwise obtain web browser extension 20 for installation in web browser 30, for example, from a third-party developer. Web browser extension 20 may come with its source code (e.g., source code 25) and/or a specification provided, for example, by the extension developer.

Security evaluation tool 101 may be configured to first extract the library dependencies of web browser extension 20. The extraction of library dependencies may be accomplished, for example, by either analyzing the source code or the specification of the extension. Extension security validator 102 and library security validator 103 in security evaluation tool 101 may be respectively configured to evaluate security risks associated with web browser extension 20 and the extracted libraries (e.g., libraries 10).

### Extension Security Validator 102

In system 100, extension security validator 102 may be configured to assign a “security score” to web browser extension 20. The security score may be based on scoring different individual key performance indicators (KPIs) that may relate to security aspects or characteristics of web browser extension 20. Example KPIs may include: (1) origin of the extension (e.g., third party developer): (2) popularity of the extension (e.g., is the extension widely used by the community?); (3) known vulnerabilities in the extension; (4) nature of the extension code (e.g., is it an open source extension or is it a proprietary extension?), etc.

To evaluate the various individual KPIs for web browser extension 20, extension security validator 102 may be configured to obtain relevant information stored in extension scoring database 104 or from external sources (e.g., extension information source 107). Extension security validator 102 may assign a security score to each of the various individual KPIs based on the results of the evaluation. For example, extension security validator 102 may assign a negative or bad score to the KPI: nature of the extension code, if the extension is an open source extension. Conversely, extension security validator 102 may assign a positive or good score to the KPI: nature of the extension code, if the extension is a proprietary extension.

Extension security validator 102 may be further configured to conduct static analysis of the source code of web browser extension 20, if such source code (e.g., source code 25) is available. Extension security validator 102 may include or use a source code scanning tool (e.g., Fortify, FlawFinder, etc.) to conduct static analysis of source code 25 of web browser extension 20. The output of the source code scanning tool may be expected to provide a list of known vulnerabilities in source code 25 of web browser extension 20. Extension security validator 102 may assign a static analysis security score to the source code based, for example, on the number or type of known vulnerabilities found by the source code scanning tool.

Extension security validator 102 may be further configured to assign an overall security score for web browser extension 20 based on the static analysis security score and individual KPI security scores. The overall security score for web browser extension 20 may be a weighted sum of the static analysis security score and individual KPI security scores. The weights in the sum may be user selectable. A user may for example, put more emphasis on the origin of the extension rather than on its popularity as a security risk or concern.

### Library Security Validator 102

In system 100, library security validator 103 may be configured to assign a “security score” to each library 10 associated with web browser extension 20. The security score may be based on scoring different individual key performance indicators (KPIs) that may relate to security aspects or characteristics of each library 10. Example KPIs may include: (1) origin of the library (e.g., third party developer): (2) popularity of the library (e.g., is the library widely used by the community?); (3) known vulnerabilities in the library; (4) nature of the extension code (e.g., is it an open source library or is it a proprietary library?), etc.

To evaluate the various individual KPIs for each library 10, library security validator 103 may be configured to obtain relevant information stored in library scoring database 105 or from external sources (e.g., library information source 108). Library security validator 103 may assign a security score to each of the various individual KPIs based on the results of the evaluation. For example, library security validator 103 may assign a negative or bad score to the KPI: nature of the library, if the library is an open source library. Conversely, library security validator 103 may assign a positive or good score to the KPI: nature of the library, if the library is a proprietary library.

Library security validator 103 may be further configured to conduct static analysis of the source code of each library 10, if such source code (e.g., source code 15) is available. Library security validator 103 may include or use a source code scanning tool (e.g., Fortify, FlawFinder, etc.) to conduct static analysis of the source code of each library 10. The output of the source code scanner tool may be expected to provide a list of known vulnerabilities in the source code of each library 10. Library security validator 103 may assign a static analysis security score to source code 15. The assigned score may, for example, be based on the number or type of known vulnerabilities found by the source code scanning tool.

Library security validator 103 may be further configured to assign an overall security score for each library 10 based on the static analysis security score and individual KPI security scores for the library. The overall security score for each library 10 may be a weighted sum of the static analysis security score and individual KPI security scores. The weights in the sum may be user selectable. A user may for example, put more emphasis on the origin of the library rather than on its popularity as security risk or concern.

### Combined Security Validator 106

In system 100, combined security validator 106 may be configured receive and process the security score outputs of extension security validator 102 and library security validator 202. Combined security validator 106 may collect the overall security score for each library 10 and the overall security score for web browser extension 20 and process these to compute a combined security score for web browser extension 20. The combined security score for web browser extension 20 may, for example, be a weighted sum of the constituent overall security score for each library 10 and the overall security score for web browser extension 20.

Combined security validator 106 may be further configured to maintain a list of security scores by web browser extension in a database (e.g., extension scoring database 104 and library scoring database 106) for further processing or future reference. This list may be made available to the users, together with the details on security scoring of individual imported libraries and extensions.

Further, combined security validator 106 may be configured to generate alerts (e.g., score notice 109) or otherwise notify the user if the combined security score for web browser extension 20 is below or above a predetermined threshold value. The predetermined threshold value may be set, for example, based on considerations of tolerable or acceptable security risk levels for the IT system hosting web browser 30/extension 20.

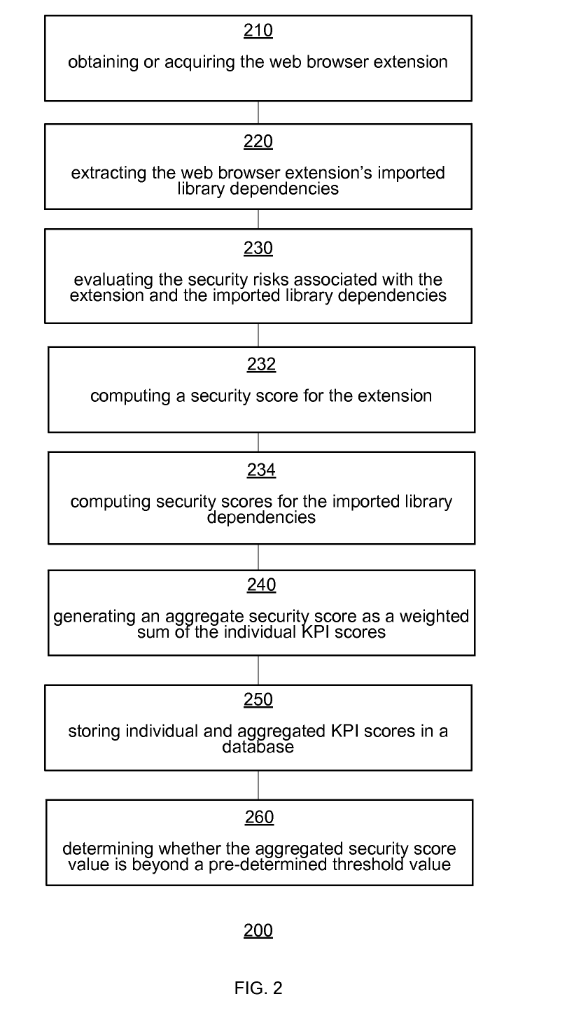

FIG. 2 shows an example computer-implemented method 200 for providing security risk evaluations of a web browser extension. Method 200 may be implemented in conjunction with or using, for example, computer-based system 100. Method 200 involves obtaining or acquiring the web browser extension (210) and extracting the web browser extension's imported library dependencies (220). The extraction of library dependencies may be accomplished either by analyzing the source code of the web browser extension if the source code is provided by the extension developer, or by analyzing the specification of the web browser extension provided by the extension developer. The extraction of library dependencies may be implemented, for example, by using security evaluation tool 101 in system 100.

Method 200 further involves evaluating the security risks associated with the extension and/or the imported library dependencies (230), computing a security score for the extension (232) and computing security scores for the imported library dependencies (234). Computing security scores 232/234 may be performed for a set of key performance indicators (KPIs) for both the web browser extension and the associated libraries. An example set of KPIs may include KPIs such as known source code vulnerabilities, popularity (i.e. number of users), and origin of the web browser extension or library, download site of web browser extension (e.g., official or unofficial web site) and a number of any other known security vulnerabilities. Evaluating the security risks associated with the extension 230 and computing a security score for the extension 232 may be implemented, for example, by using extension security validator 102 in system 100. Similarly, evaluating the security risks associated with the imported library dependencies 230 and computing security scores for the imported library dependencies (234) may be implemented, for example, by using library security validator 103 in system 100

For each KPI, a specific scoring algorithm may be applied to compute a security score. For example, for the source code vulnerabilities KPI, a source code scanning tool may be used to determine the number of identified flaws in a specific piece of software. Reputation of the source or the developer, and/or popularity of the extension may be taken into account into the computation of the security scoring.

After the individual KPIs are scored, method 200 may involve generating an aggregate security score as a weighted sum of the individual KPI scores (240). The weights used for the weighted sum may be KPI weights that are user-defined. These user-defined KPI weights may be stored a database and made available to method 200 for computing the weighted sum of the individual KPI scores. Generating the aggregate security score as a weighted sum of the individual KPI scores 240 may be implemented, for example, by using combined security validator 106 in system 100.

Method 200 may involve storing of the results of the security risk evaluations for further use or analysis. Method 200 may, for example, involve storing individual and aggregated KPI scores in a database (250). In system 100, storing individual and aggregated KPI scores in a database 250 may involve storing the data, for example, in extension scoring database 104 and library scoring database 105.

Analysis of the results of the security risk evaluations may involve determining whether the aggregated security score value is beyond a pre-determined threshold value (260) indicating that there may be an unacceptable level of security risks associated with the web browser extension. In such case, depending on the score, different actions may be undertaken automatically, ranging, for example, from a simple notification to the user, un-installation of the extension, to an email sent to the administrator, etc. In an example implementation of method 200, the user and/or system administrator may be notified of the security risks, for example, via a pop-up notification in the web browser that there are security risks associated with a downloaded web browser extension that are beyond the pre-determined threshold value.

An example implementation of method 200 may further involve retrieving detailed information regarding the security risks from external information sources (e.g., common weakness enumeration available at web site cwe.miter.org). The retrieved detailed information may be provided to the user and/or system administrator for further action.

Method 200 may be run on a regular schedule (e.g., weekly or monthly). Method 200 may include checking if there have been any updates to the installed web browser extension. If there has been an update, then method 200 may evaluate and score the updated extension as described above (210-260).

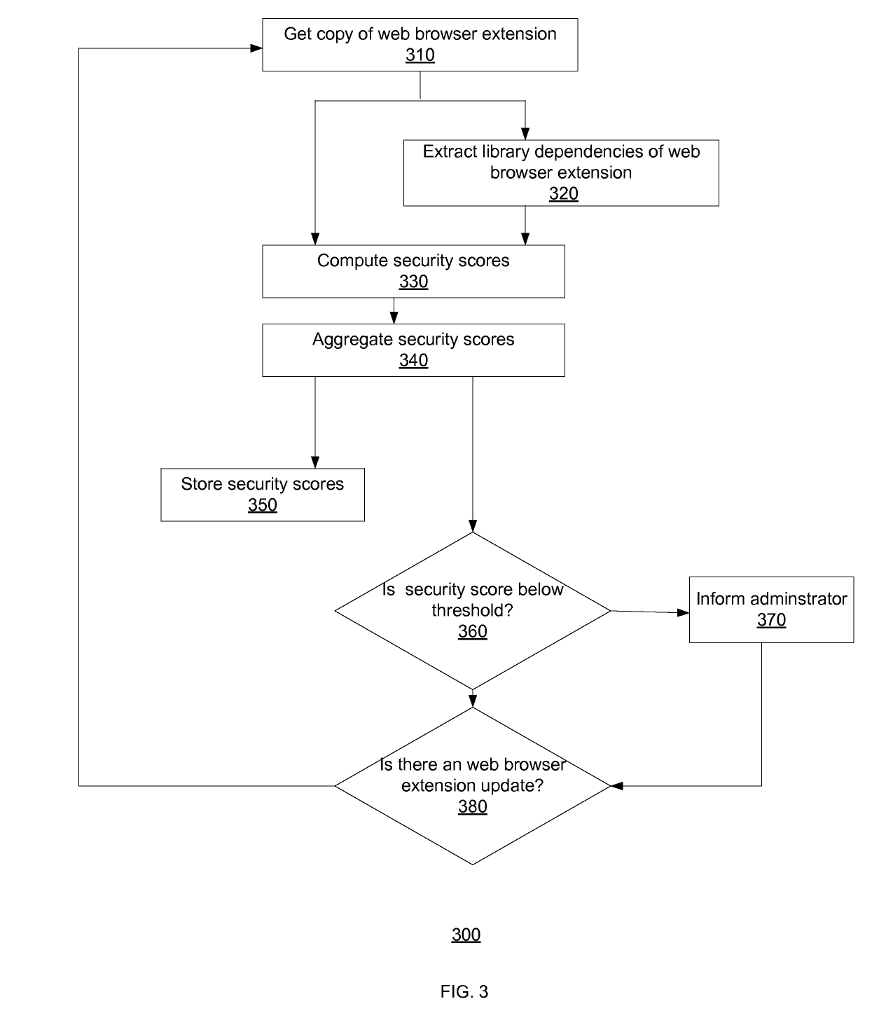

FIG. 3 is a flowchart illustrating the logic of an example method 300 that is implemented to continuously or regularly monitor updates to a web browser extension to a web browser installed on a computer system, in accordance with the principles of the disclosure herein.

Method 300, like method 200, may include getting a copy of the web browser extension (310), extracting the web browser extension's imported library dependencies (320), computing security scores for both the web browser extension and the imported library dependencies (330), aggregating the scores (340) and storing the scores (350).

Method 300 may include determining if the aggregated score is below a threshold value (360) and accordingly informing a user (e.g., a system administrator) 370 for further action or instructions. If the aggregated score is not below the threshold value (or if instructed by the user) method 300 may proceed to monitor or check is there is any update to the web browser extension (380). In case there is an update, then method 300 may evaluate and score the updated web browser extension as described above (310-370).

The various infrastructure, systems, techniques, and methods described herein may be implemented in digital electronic circuitry, or in computer hardware, firmware, software, or in combinations of them. The implementations may be a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-based system implemented by instructions recorded on a non-transitory computer readable storage medium and executable by at least one processor, the computer-based system comprising:
a security evaluation tool configured to extract dependencies of one or more imported libraries associated with a web browser extension added to a web browser and configured to evaluate security risks associated with addition of the web browser extension to the web browser, the security evaluation tool including:
a web browser extension security validator configured to evaluate security risks associated with the web browser extension itself; and
a library security validator configured to evaluate security risks associated with the one or more imported libraries associated with the web browser extension.

2. The computer-based system of claim 1, wherein the web browser extension security validator includes at least one static source code scanning tool, and wherein the web browser extension security validator is configured to examine of the web browser extension's source code for patterns of identified vulnerabilities.

3. The computer-based systems of claim 1, wherein the web browser extension security validator is configured to evaluate security risks associated with the web browser extension for one or more key performance indicators (KPIs) and assign a security score to the web browser extension for each of the one or more KPIs.

4. The computer-based system of claim 3, wherein the one or more KPIs include at least one of origin of the extension, popularity of the extension, known vulnerabilities in the extension, and nature of the extension.

5. The computer-based system of claim 3, wherein the web browser extension security validator is configured to assign a quantitative security score to the web browser extension for each of the one or more KPIs evaluated.

6. The computer-based systems of claim 5, wherein the library security validator is configured to evaluate security risks associated with each of the one or more imported libraries for one or more key performance indicators (KPIs) and assign a quantitative security score to each library for each of the one or more KPIs evaluated.

7. The computer-based system of claim 6, wherein the security evaluation tool is configured to compute an aggregate security score for the web browser extension from the security scores assigned to the web browser extension for each of the one or more KPIs evaluated and the security scores assigned to each library for each of the one or more KPIs evaluated.

8. The computer-based system of claim 7, wherein the security evaluation tool is configured to determine whether the aggregate security score is beyond a pre-determined threshold value indicating that there may be an unacceptable level of security risks associated with the web browser extension.

9. The computer-based system of claim 8, wherein the security evaluation tool is configured notify a user if the aggregated security score is beyond the pre-determined threshold value indicating an unacceptable level of security risks associated with the web browser extension.

10. A computer-implemented method carried out by causing at least one processor to execute instructions recorded on a computer-readable storage medium, the computer-implemented method comprising:
obtaining a web browser extension to a web browser;
extracting the web browser extension's imported library dependencies; and
evaluating security risks associated with the web browser extension and the imported library dependencies.

11. The computer-implemented method of claim 10, wherein evaluating security risks associated with the web browser extension and the imported library dependencies includes computing security scores for key performance indicators (KPIs) of the extension and the imported library dependencies.

12. The computer-implemented method of claim 11, wherein the one or more KPIs include at least one of: origin of the extension, popularity of the extension, known vulnerabilities in the extension, and nature of the extension.

13. The computer-implemented method of claim 11 further comprising generating an aggregate security score as a weighted sum of individual KPI security scores.

14. The computer-implemented method of claim 13 further comprising storing the individual and aggregate KPI security scores in a database.

15. The computer-implemented method of claim 14 further comprising determining whether the aggregated security score is beyond a pre-determined threshold value.

16. The computer-implemented method of claim 15 further comprising notifying a user if the aggregated security score is beyond the pre-determined threshold value indicating an unacceptable level of security risks associated with the web browser extension.

17. A computer program product embodied in non-transitory computer-readable media carrying executable code, which code when executed:
obtains a web browser extension to a web browser;
extracts the web browser extension's imported library dependencies; and
evaluates security risks associated with the web browser extension and the imported library dependencies.

18. The computer program product of claim 17, wherein the code when executed:
computes security scores for key performance indicators (KPIs) of the extension and the imported library dependencies.

19. The computer program product of claim 18, wherein the code when executed:
generates an aggregate security score as a weighted sum of individual KPI security scores.

20. The computer program product of claim 19, wherein the code when executed:
determines whether the aggregated security score is above or below a pre-determined threshold value; and,
accordingly generates and provides a notification to a user.
